(19) United States
(12) Patent Application Publication
(10) Pub. No.: US 2026/0099781 A1
(43) Pub. Date: Apr. 9, 2026

(54) TECHNIQUES FOR SELECTING AND BENCHMARKING PAIRING STRATEGIES IN A TASK ASSIGNMENT SYSTEM

(71) Applicant: Afiniti AI Limited, Dublin (IE)

(72) Inventor: Wahaj ZUBERI, Islamabad (PK)

(73) Assignee: Afiniti AI Limited, Dublin (IE)

(21) Appl. No.: 19/416,261

(22) Filed: Dec. 11, 2025

Related U.S. Application Data
(63) Continuation of application No. PCT/US2024/033839, filed on Jun. 13, 2024.
(60) Provisional application No. 63/472,977, filed on Jun. 14, 2023.

(51) Int. Cl. G06Q 10/0631; H04M 3/523

(52) U.S. Cl. CPC G06Q 10/063112; H04M 3/523

(57) ABSTRACT

There is provided a method comprising obtaining contact information that indicates a plurality of contacts in a queue. The plurality of contacts includes a first set of contacts associated with a first pairing strategy (PS) and a second set of contacts associated with a second PS. The method comprises obtaining agent information that indicates one or more agents and selecting a first contact from among the plurality of contacts based on a value of a first parameter associated with the first contact. The value of the first parameter indicates whether the first contact was skipped from pairing with an agent since the first contact was placed in the queue. The method comprises determining that the first contact is associated with the first PS and applying the first PS for pairing one or more contacts included in the first set of contacts with one or more agents.

### CROSS-REFERENCE TO RELATED APPLICATIONS

This application is a continuation of International Patent Application No. PCT/US2024/033839, filed on 2024 Jun. 13, which claims the benefit of U.S. provisional patent application No. 63/472,977, filed on 2023 Jun. 14. The above identified applications are incorporated by this reference.

### TECHNICAL FIELD

This disclosure generally relates to techniques for selecting and benchmarking pairing strategies (PSs) in a task assignment system.

### BACKGROUND

A typical contact center algorithmically assigns contacts arriving at the contact center to agents available to handle those contacts. At times, the contact center may have agents available and waiting for assignment to inbound or outbound contacts (e.g., telephone calls, Internet chat sessions, email) or outbound contacts. At other times, the contact center may have contacts waiting in one or more queues for an agent to become available for assignment.

In some typical contact centers, contacts are assigned to agents ordered based on time of arrival, and agents receive contacts ordered based on the time when those agents became available. This strategy may be referred to as a “first-in, first-out”, “FIFO”, or “round-robin” strategy. For example, a longest-available agent pairing strategy preferably selects the available agent who has been available for the longest time.

Some contact centers may use a “performance based routing” or “PBR” approach to ordering the queue of available agents or, occasionally, contacts. PBR ordering strategies attempt to maximize the expected outcome of each contact-agent interaction but do so typically without regard for utilizing agents in a contact center uniformly. Some variants of PBR may include a highest-performing-agent pairing strategy, preferably selecting the available agent with the highest performance, or a highest-performing-agent-for-contact-type pairing strategy, preferably selecting the available agent with the highest performance for the type of contact being paired.

For yet another example, some contact centers may use a “behavioral pairing” or “BP” strategy, under which contacts and agents may be deliberately (preferentially) paired in a fashion that enables the assignment of subsequent contact-agent pairs such that when the benefits of all the assignments under a BP strategy are totaled they may exceed those of FIFO and PBR strategies. BP is designed to encourage balanced utilization of agents within a skill queue while nevertheless simultaneously improving overall contact center performance beyond what FIFO or PBR methods will allow. This is a remarkable achievement inasmuch as BP acts on the same calls and same agents as FIFO or PBR methods, utilizes agents approximately evenly as FIFO provides, and yet improves overall contact center performance. BP is described in, e.g., U.S. patent application Ser. No. 14/871,658, filed Sep. 30, 2015 (now U.S. Pat. No. 9,300,802 issued on 2016 Mar. 29), which is incorporated by reference herein. Additional information about these and other features regarding the pairing or matching modules (sometimes also referred to as “SATMAP”, “routing system”, “routing engine”, etc.) is described in, for example, U.S. Pat. No. 8,879,715, which is incorporated herein by reference.

Some contact centers may use a variety of other possible pairing strategies. For example, in a longest-available agent pairing strategy, an agent may be selected who has been waiting (idle) the longest time since the agent's most recent contact interaction (e.g., call) has ended. In a least-occupied agent pairing strategy, an agent may be selected who has the lowest ratio of contact interaction time to waiting or idle time (e.g., time spent on calls versus time spent off calls). In a fewest-contact-interactions-taken-by-agent pairing strategy, an agent may be selected who has the fewest total contact interactions or calls. In a randomly-selected-agent pairing strategy, an available agent may be selected at random (e.g., using a pseudorandom number generator). In a sequentially-labeled-agent pairing strategy, agents may be labeled sequentially, and the available agent with the next label in sequence may be selected.

In situations where multiple contacts are waiting in a queue, and an agent becomes available for connection to one of the contacts in the queue, a variety of pairing strategies may be used. For example, in a FIFO or longest-waiting-contact pairing strategy, the agent may be preferably paired with the contact that has been waiting in queue the longest (e.g., the contact at the head of the queue). In a randomly-selected-contact pairing strategy, the agent may be paired with a contact selected at random from among all or a subset of the contacts in the queue. In a priority-based routing or highest-priority-contact pairing strategy, the agent may be paired with a higher-priority contact even if a lower-priority contact has been waiting in the queue longer.

Some contact centers may switch (or “cycle”) periodically among at least two different pairing strategies (e.g., between FIFO and PBR; between PBR and BP; among FIFO, PBR, and BP). Additionally, the outcome of each contact-agent interaction may be recorded along with an identification of which pairing strategy (e.g., FIFO, PBR, or BP) had been used to assign that particular contact-agent pair. By tracking which interactions produced which results, the contact center may measure the performance attributable to a first strategy (e.g., FIFO pairing strategy) and the performance attributable to a second strategy (e.g., PBR). In this way, the relative performance of one strategy may be benchmarked against the other. The contact center may, over many periods of switching between different pairing strategies, more reliably attribute performance gain to one strategy or the other.

### SUMMARY

Certain challenges presently exist. For example, in evaluating the performance of various pairing strategies (PSs) (i.e., in benchmarking various PSs), the sequence selecting which pairing strategy of a set of PSs and of performing the evaluation needs to be determined. More specifically, in case a first PS (e.g., the FIFO PS) and a second PS (e.g., the BP strategy) are sequentially applied during a benchmarking period (i.e., the period of evaluating the performance of the first and second PSs), it must be determined as to which one of the first PS and the second PS should be applied during the benchmarking period at every opportunity that contact-agent pairing is selected during the benchmarking period. In determining which one of the first PS and the second PS to apply at each opportunity to select a contact-agent pairing during the benchmarking period, a technique called “Tie-Breaking” (“TB”) may be used.

The TB determines whether a contact should be paired with an agent using a particular PS. For example, the TB may identify the head of a contact queue using specific sorting criteria. However, in case the one of the PSs of the set of PSs applied for pairing during the benchmarking period has an out-of-sequence pairing nature (e.g., such as the BP strategy where contacts may be paired out-of-sequence), there is a possibility that the head of the contact queue, even when using the specific sorting criteria, may be skipped by the PS with the out-of-sequence pairing nature.

Specific sorting criterion may include: (1) sorting mechanisms required by a contact center switch (e.g., “ACD order”), (2) demotion-promotion techniques, which demotes a first contact and promotes a second contact, which first contact is identified to be paired with a first PS, was skipped by the first PS, and is sequentially before the second contact, which second contact is identified to be paired with a second PS, which second PS may be a sequential PS, and (3) priority-based TB techniques which may use priority of each contact in a queue to sort the queue. Many features may complicate the use of these sorting criteria and expose flaws in the criteria, which may unintentionally prioritize one PS in the set of PSs over the other PSs, or bias the selection of contacts associated with a first PS over the other PSs in the set of PSs, such that contacts associated with the other PSs may experience increased waiting times compared to contacts associated with the first PS, reducing throughput and efficiency of the contact center. These features include: the complexity of the contact center's priority schema (e.g., service objectives or dynamic priorities associated with the contacts), the number of contacts in the queue, attributes of the contacts in queue (e.g., required skills), the number of agents available for pairing, attributes of the available agents (e.g., available skills), etc.

Therefore, what is needed is a schema for tie-breaking that accommodates such complex, dynamic contact center environments, may provide increased advantages including maintaining relatively constant wait times between contacts across pairing strategies and/or increased throughput of the contact center system, and avoids adding more attributes or complexities to existing TB strategies.

According to some embodiments, there is provided a method comprising: obtaining contact information that indicates a plurality of contacts in a queue, wherein the plurality of contacts includes a first set of one or more contacts associated with a first pairing strategy (PS) and a second set of one or more contacts associated with a second PS; obtaining agent information that indicates one or more agents; selecting a first contact from among the plurality of contacts based on a value of a first parameter associated with the first contact, wherein the value of the first parameter indicates whether the first contact was skipped from pairing with an agent since the first contact was placed in the queue; determining that the first contact is associated with the first PS; and applying the first PS for pairing one or more contacts included in the first set of contacts with one or more agents.

In another aspect, there is a computer program comprising instructions which when executed by processing circuitry cause the processing circuitry to perform the method of at least one of the above embodiments.

In another aspect, there is provided an apparatus being configured to obtain contact information that indicates a plurality of contacts in a queue, wherein the plurality of contacts includes a first set of one or more contacts associated with a first pairing strategy (PS) and a second set of one or more contacts associated with a second PS; obtain agent information that indicates one or more agents; select a first contact from among the plurality of contacts based on a value of a first parameter associated with the first contact, wherein the value of the first parameter indicates whether the first contact was skipped from pairing with an agent since the first contact was placed in the queue; determine that the first contact is associated with the first PS; and apply the first PS for pairing one or more contacts included in the first set of contacts with one or more agents.

In another aspect, there is provided an apparatus comprising a memory; and processing circuitry coupled to the memory, wherein the apparatus is configured to perform the method of at least one of the above embodiments.

Some embodiments of this disclosure allow balancing the selection of contact-agent pairings according to multiple PSs and the evaluation of the performance of multiple PSs, while keeping fewest general attributes associated with each contact, and which disclosed techniques are agnostic to any sorting complexity.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1A illustrates an example communication system according to an embodiment.

FIG. 1B illustrates an example communication system according to an embodiment.

FIG. 1C illustrates an example communication system according to an embodiment.

FIG. 1D illustrates an example communication system according to an embodiment.

FIG. 2A shows a schematic representation of benchmarking sequence according to some embodiments.

FIG. 2B shows a schematic representation of benchmarking sequence according to some embodiments.

FIGS. 3A and 3B show examples of a queue.

FIG. 4 shows a process according to some embodiments.

FIG. 5 shows a process according to some embodiments.

FIG. 6 shows an apparatus according to some embodiments.

FIGS. 7A and 7B show examples of a queue.

FIG. 8 shows a system according to some embodiments.

### DETAILED DESCRIPTION

The description herein describes network elements, computers, and/or components of a system and method for pairing strategies in a task assignment system that may include one or more modules. As used herein, the term “module” may be understood to refer to computing software, firmware, hardware, and/or various combinations thereof. Modules, however, are not to be interpreted as software which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices. Furthermore, in this disclosure, “contact” and “call” are used interchangeably.

A typical contact center algorithmically assigns contacts arriving at the contact center to agents available to handle those contacts. At times, the contact center may have agents available and waiting for assignment to inbound or outbound contacts (e.g., telephone calls, Internet chat sessions, email) or outbound contacts. At other times, the contact center may have contacts waiting in one or more queues for an agent to become available for assignment.

In some typical contact centers, contacts are assigned to agents ordered based on time of arrival, and agents receive contacts ordered based on the time when those agents became available. This strategy may be referred to as a “first-in, first-out”, “FIFO”, or “round-robin” strategy. For example, a longest-available agent pairing strategy preferably selects the available agent who has been available for the longest time.

Some contact centers may use a “performance based routing” or “PBR” approach to ordering the queue of available agents or, occasionally, contacts. PBR ordering strategies attempt to maximize the expected outcome of each contact-agent interaction but do so typically without regard for utilizing agents in a contact center uniformly. Some variants of PBR may include a highest-performing-agent pairing strategy, preferably selecting the available agent with the highest performance, or a highest-performing-agent-for-contact-type pairing strategy, preferably selecting the available agent with the highest performance for the type of contact being paired.

For yet another example, some contact centers may use a “behavioral pairing” or “BP” strategy, under which contacts and agents may be deliberately (preferentially) paired in a fashion that enables the assignment of subsequent contact-agent pairs such that when the benefits of all the assignments under a BP strategy are totaled they may exceed those of FIFO and PBR strategies. BP is designed to encourage balanced utilization of agents within a skill queue while nevertheless simultaneously improving overall contact center performance beyond what FIFO or PBR methods will allow. This is a remarkable achievement inasmuch as BP acts on the same calls and same agents as FIFO or PBR methods, utilizes agents approximately evenly as FIFO provides, and yet improves overall contact center performance. BP is described in, e.g., U.S. patent application Ser. No. 14/871,658, filed Sep. 30, 2015, which is incorporated by reference herein. Additional information about these and other features regarding the pairing or matching modules (sometimes also referred to as “SATMAP”, “routing system”, “routing engine”, etc.) is described in, for example, U.S. Pat. No. 8,879,715, which is incorporated herein by reference.

Some contact centers may use a variety of other possible pairing strategies. For example, in a longest-available agent pairing strategy, an agent may be selected who has been waiting (idle) the longest time since the agent's most recent contact interaction (e.g., call) has ended. In a least-occupied agent pairing strategy, an agent may be selected who has the lowest ratio of contact interaction time to waiting or idle time (e.g., time spent on calls versus time spent off calls). In a fewest-contact-interactions-taken-by-agent pairing strategy, an agent may be selected who has the fewest total contact interactions or calls. In a randomly-selected-agent pairing strategy, an available agent may be selected at random (e.g., using a pseudorandom number generator). In a sequentially-labeled-agent pairing strategy, agents may be labeled sequentially, and the available agent with the next label in sequence may be selected.

In situations where multiple contacts are waiting in a queue, and an agent becomes available for connection to one of the contacts in the queue, a variety of pairing strategies may be used. For example, in a FIFO or longest-waiting-contact pairing strategy, the agent may be preferably paired with the contact that has been waiting in queue the longest (e.g., the contact at the head of the queue). In a randomly-selected-contact pairing strategy, the agent may be paired with a contact selected at random from among all or a subset of the contacts in the queue. In a priority-based routing or highest-priority-contact pairing strategy, the agent may be paired with a higher-priority contact even if a lower-priority contact has been waiting in the queue longer.

In some embodiments, a contact center may switch (or “cycle”) periodically among at least two different pairing strategies (e.g., between FIFO and PBR; between PBR and BP; among FIFO, PBR, and BP). Additionally, the outcome of each contact-agent interaction may be recorded along with an identification of which pairing strategy (e.g., FIFO, PBR, or BP) had been used to assign that particular contact-agent pair. By tracking which interactions produced which results, the contact center may measure the performance attributable to a first strategy (e.g., FIFO) and the performance attributable to a second strategy (e.g., PBR). In this way, the relative performance of one strategy may be benchmarked against the other. The contact center may, over many periods of switching between different pairing strategies, more reliably attribute performance gain to one strategy or the other.

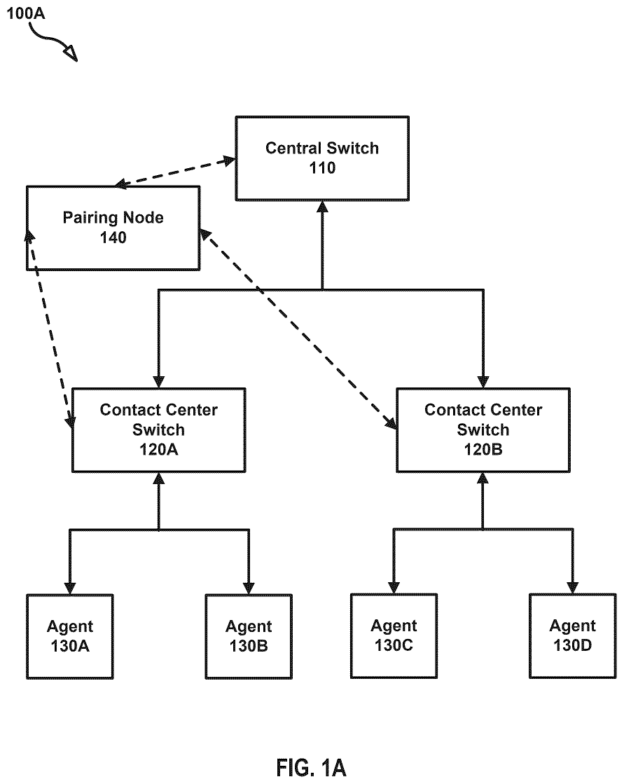

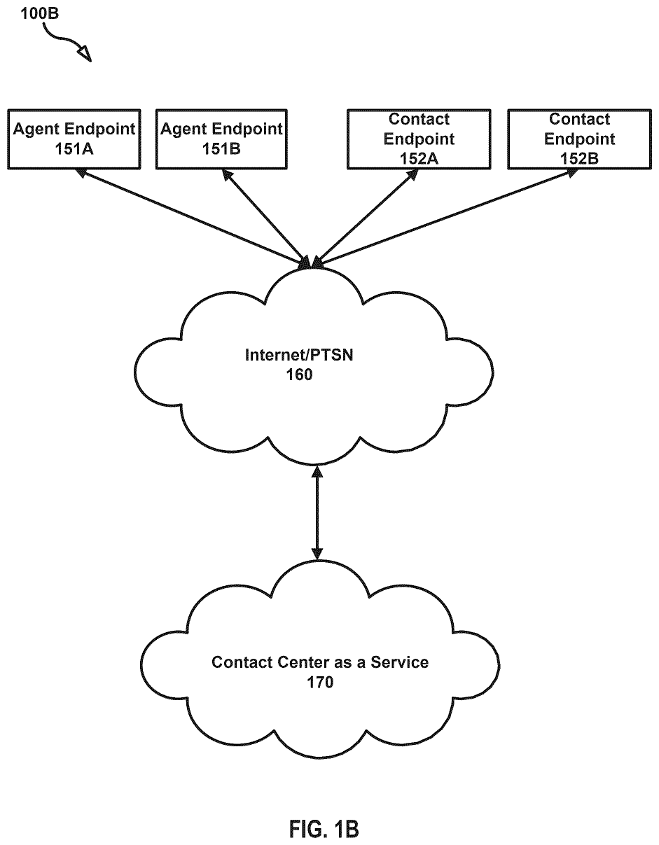

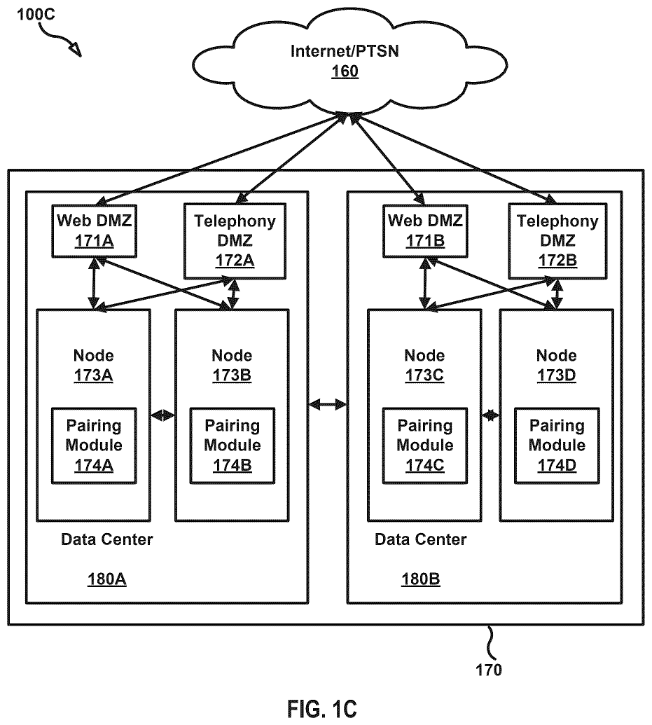

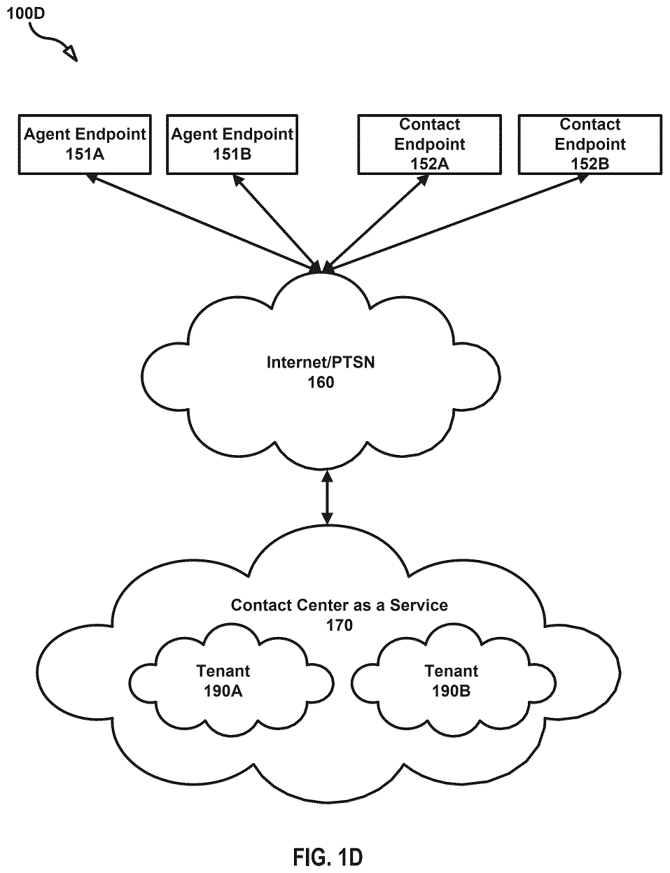

FIG. 1A illustrates an example communication system 100A. In this example, communication system 100A is a contact center system. As shown in FIG. 1A, the communication system 100A may include a central switch 110. The central switch 110 may receive incoming contacts (e.g., callers) or support outbound connections to contacts via a telecommunications network (not shown). The central switch 110 may include contact routing hardware and software for helping to route contacts among one or more contact centers, or to one or more Private Branch Exchanges (PBXs) and/or Automatic Call Distributers (ACDs) or other queuing or switching components, including other Internet-based, cloud-based, or otherwise networked contact-agent hardware or software-based contact center solutions.

The central switch 110 may not be necessary such as if there is only one contact center, or if there is only one PBX/ACD routing component, in the communication system 100A. If more than one contact center is part of the communication system 100A, each contact center may include at least one contact center switch (e.g., contact center switches 120A and 120B). The contact center switches 120A and 120B may be communicatively coupled to the central switch 110. In embodiments, various topologies of routing and network components may be configured to implement the contact center system.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break.

In the example of FIG. 1A, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B.

The communication system 100A may also be communicatively coupled to an integrated service from, for example, a third party vendor. In the example of FIG. 1A, a pairing node 140 may be communicatively coupled to one or more switches in the switch system of the communication system 100A, such as central switch 110, contact center switch 120A, or contact center switch 120B. In some embodiments, switches of the communication system 100A may be communicatively coupled to multiple pairing nodes. In some embodiments, pairing node 140 may be embedded within a component of a contact center system (e.g., embedded in or otherwise integrated with a switch). The pairing node 140 may receive information from a switch (e.g., contact center switch 120A) about agents logged into the switch (e.g., agents 130A and 130B) and about incoming contacts via another switch (e.g., central switch 110) or, in some embodiments, from a network (e.g., the Internet or a telecommunications network) (not shown).

A contact center may include multiple pairing nodes. In some embodiments, one or more pairing nodes may be components of pairing node 140 or one or more switches such as central switch 110 or contact center switches 120A and 120B. In some embodiments, a pairing node may determine which pairing node may handle pairing for a particular contact. For example, the pairing node may alternate between enabling pairing via a Behavioral Pairing (BP) strategy and enabling pairing with a First-in-First-out (FIFO) strategy. In other embodiments, one pairing node (e.g., the BP pairing node) may be configured to emulate other pairing strategies.

FIG. 1B illustrates a second example communication system 100B. As shown in FIG. 1B, the communication system 100B may include one or more agent endpoints 151A, 151B and one or more contact endpoints 152A, 152B. The agent endpoints 151A, 151B may include an agent terminal and/or an agent computing device (e.g., laptop, cellphone). The contact endpoints 151A, 151B may include a contact terminal and/or a contact computing device (e.g., laptop, cellphone). Agent endpoints 151A, 151B and/or contact endpoints 152A, 152B may connect to a Contact Center as a Service (CCaaS) 170 through either the Internet or a public switched telephone network (PSTN), according to the capabilities of the endpoint device.

FIG. 1C illustrates an example communication system 100C with an example configuration of a CCaaS 170. For example, a CCaaS 170 may include multiple data centers 180A, 180B. The data centers 180A, 180B may be separated physically, even in different countries and/or continents. The data centers 180A, 180B may communicate with each other. For example, one data center is a backup for the other data center; so that, in some embodiments, only one data center 180A or 180B receives agent endpoints 151A, 151B and contact endpoints 152A, 152B at a time.

Each data center 180A, 180B includes web demilitarized zone equipment 171A and 171B, respectively, which is configured to receive the agent endpoints 151A, 151B and contact endpoints 152A, 152B, which are communicatively connecting to CCaaS via the Internet. Web demilitarized zone (DMZ) equipment 171A and 171B may operate outside a firewall to connect with the agent endpoints 151A, 151B and contact endpoints 152A, 152B while the rest of the components of data centers 180A, 180B may be within said firewall (besides the telephony DMZ equipment 172A, 172B, which may also be outside said firewall). Similarly, each data center 180A, 180B includes telephony DMZ equipment 172A and 172B, respectively, which is configured to receive agent endpoints 151A, 151B and contact endpoints 152A, 152B, which are communicatively connecting to CCaaS via the PSTN. Telephony DMZ equipment 172A and 172B may operate outside a firewall to connect with the agent endpoints 151A, 151B and contact endpoints 152A, 152B while the rest of the components of data centers 180A, 180B (excluding web DMZ equipment 171A, 171B) may be within said firewall.

Further, each data center 180A, 180B may include one or more nodes 173A, 173B, and 173C, 173D, respectively. All nodes 173A, 173B and 173C, 173D may communicate with web DMZ equipment 171A and 171B, respectively, and with telephony DMZ equipment 172A and 172B, respectively. In some embodiments, only one node in each data center 180A, 180B may be communicating with web DMZ equipment 171A, 171B and with telephony DMZ equipment 172A, 172B at a time.

Each node 173A, 173B, 173C, 173D may have one or more pairing modules 174A, 174B, 174C, 174D, respectively. Similar to pairing module 140 of communications system 100A of FIG. 1A, pairing modules 174A, 174B, 174C, 174D may pair contacts to agents. For example, the pairing module may alternate between enabling pairing via a Behavioral Pairing (BP) module and enabling pairing with a First-in-First-out (FIFO) module. In other embodiments, one pairing module (e.g., the BP module) may be configured to emulate other pairing strategies.

Turning now to FIG. 1D, the disclosed CCaaS communication systems (e.g., FIGS. 1B and/or 1C) may support multi-tenancy such that multiple contact centers (or contact center operations or businesses) may be operated on a shared environment. That is, each tenant may have a separate, non-overlapping pool of agents. CCaaS 170 is shown in FIG. 1D as comprising two tenants 190A and 190B. Turning back to FIG. 1C, for example, multi-tenancy may be supported by node 173A supporting tenant 190A while node 173B supports 190B. In another embodiment, data center 180A supports tenant 190A while data center 180B supports tenant 190B. In another example, multi-tenancy may be supported through a shared machine or shared virtual machine; such at node 173A may support both tenants 190A and 190B, and similarly for nodes 173B, 173C, and 173D. In other embodiments, the system may be configured for a single tenant within a dedicated environment such as a private machine or private virtual machine.

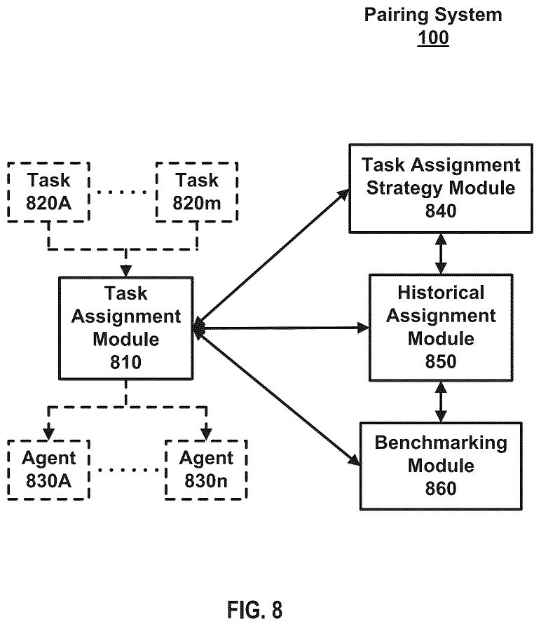

FIG. 8 shows a block diagram of a pairing system 100 according to some embodiments of the present disclosure. The pairing system 100 may be included in a task assignment system (e.g., contact center system) or incorporated in a component or module (e.g., a pairing module) of a task assignment system for helping to assign tasks (e.g., contacts) among various agents.

The pairing system 100 may include a task assignment module 810 that is configured to pair (e.g., match, assign) incoming tasks to available agents. In the example of FIG. 8, m tasks 820A-820m are received over a given period, and n agents 830A-830 n are available during the given period. Each of the m tasks may be assigned to one of the n agents for servicing or other types of task processing. In the example of FIG. 8, m and n may be arbitrarily large finite integers greater than or equal to one. In a real-world task assignment system, such as a contact center system, there may be dozens, hundreds, etc. of agents logged into the contact center system to interact with contacts during a shift, and the contact center system may receive dozens, hundreds, thousands, etc. of contacts (e.g., telephone calls, internet chat sessions, emails, etc.) during the shift.

In some embodiments, a task assignment strategy module 840 may be communicatively coupled to and/or configured to operate in the pairing system 100. The task assignment strategy module 840 may implement one or more task assignment strategies (or “pairing strategies”) for assigning individual tasks to individual agents (e.g., pairing contacts with contact center agents). A variety of different task assignment strategies may be devised and implemented by the task assignment strategy module 840. In some embodiments, a FIFO strategy may be implemented in which, for example, the longest-waiting agent receives the next available task (in L1 environments) or the longest-waiting task is assigned to the next available agent (in L2 environments). In other embodiments, a PBR strategy for prioritizing higher-performing agents for task assignment may be implemented. Under PBR, for example, the highest-performing agent among available agents receives the next available task. In yet other embodiments, a BP strategy may be used for optimally assigning tasks to agents using information about either tasks or agents, or both. Various BP strategies may be used, such as a diagonal model BP strategy or an off-diagonal strategy such as a network flow BP strategy. See U.S. Pat. Nos. 9,300,802; 9,781,269; 9,787,841; and 9,930,180.

In some embodiments, a historical assignment module 850 may be communicatively coupled to and/or configured to operate in the pairing system 100 via other modules such as the task assignment module 810 and/or the task assignment strategy module 840. The historical assignment module 850 may be responsible for various functions such as monitoring, storing, retrieving, and/or outputting information about task-agent assignments that have already been made. For example, the historical assignment module 850 may monitor the task assignment module 810 to collect information about task assignments in a given period. Each record of a historical task assignment may include information such as an agent identifier, a task or task type identifier, offer or offer set identifier, outcome information, or a pairing strategy identifier (i.e., an identifier indicating whether a task assignment was made using a BP strategy, or some other pairing strategy such as a FIFO or PBR pairing strategy).

In some embodiments and for some contexts, additional information may be stored. For example, in a call center context, the historical assignment module 850 may also store information about the time a call started, the time a call ended, the phone number dialed, and the caller's phone number. For another example, in a dispatch center (e.g., “truck roll”) context, the historical assignment module 850 may also store information about the time a driver (i.e., field agent) departs from the dispatch center, the route recommended, the route taken, the estimated travel time, the actual travel time, the amount of time spent at the customer site handling the customer's task, etc.

In some embodiments, the historical assignment module 850 may generate a pairing model or a similar computer processor-generated model based on a set of historical assignments for a period of time (e.g., the past week, the past month, the past year, etc.), which may be used by the task assignment strategy module 840 to make task assignment recommendations or instructions to the task assignment module 810.

In some embodiments, a benchmarking module 860 may be communicatively coupled to and/or configured to operate in the pairing system 100 via other modules such as the task assignment module 810 and/or the historical assignment module 850. The benchmarking module 860 may designate incoming tasks as “ON” or “OFF” tasks. As described later, the pairing system handles the assignment of tasks to agents differently based on the “ON” or “OFF” labels assigned to the tasks. In some embodiments, the benchmarking module 860 may perform other functions, such as establishing a benchmarking schedule for cycling among various pairing strategies, tracking cohorts (e.g., base and measurement groups of historical assignments), etc. In some embodiments, the benchmarking module may be programmed with different benchmarking techniques such as, epoch benchmarking and inline benchmarking. Benchmarking is described in detail for the contact center context in, e.g., U.S. Pat. No. 9,712,676, which is hereby incorporated by reference herein.

In some embodiments, the benchmarking module 860 may output or otherwise report or use the relative performance measurements. The relative performance measurements may be used to assess the quality of a pairing strategy to determine, for example, whether a different pairing strategy (or a different pairing model) should be used, or to measure the overall performance (or performance gain) that was achieved within the task assignment system while it was optimized or otherwise configured to use one pairing strategy instead of another.

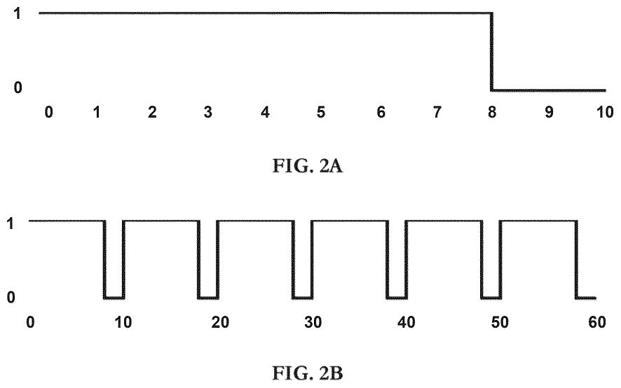

FIGS. 2A and 2B show examples of the method of benchmarking a first pairing strategy (PS) and a second PS according to some embodiments. In FIGS. 2A and 2B, the horizontal axis represents time, and the vertical axis represents whether a first PS (“1”) or a second PS (“0”) is used.

As explained above, in benchmarking the first PS and the second PS, the sequence of the benchmarking (i.e., whether to evaluate the performance of the first PS first by using the first PS first for the pairing or the performance of the second PS first by using the second PS first for the pairing) needs to be determined, and in determining such sequence, the TB may be used.

Accordingly, some embodiments of this disclosure provide a method, an apparatus, and/or a system for finding, from among a plurality of contacts in a queue, a TB contact which can be used for determining which PS to benchmark first and/or which can be used to identify which PS of a set of PSs should determine the next contact-agent pairing. In these embodiments, a contact may be associated with any one or more of the following parameters: “benchmark,” “queue time,” “priority,” “skipped,” “counter,” “skip batch time,” and “TB.”

The value of the “benchmark” parameter may indicate which PS of a set of PSs will be used to pair the contact to which the value is associated. In one example, where the set of PSs used by the contact center system comprises two PSs, the value of the “benchmark” parameter may be a binary value. In said example, the parameter value of 0 may indicate that a first PS of the set of PSs is to be used for pairing the corresponding contact with an agent while the parameter value of 1 may indicate that a second PS of the set of PSs is to be used for pairing the corresponding contact with an agent.

The value of the “queue time” parameter may be based on a time when a corresponding contact was placed in the queue of contacts; for example, the “queue time” parameter value may be or may be based on a time stamp of when the contact joined the queue, a length of time that the contact has been in the queue, a wait time, etc.

The value of the “priority” parameter indicates a priority level of a corresponding contact. In one example, the value of the “priority” parameter may be a positive integer, and a higher value of the parameter may indicate a higher priority.

The value of the “skipped” parameter may indicate whether a corresponding contact had ever been skipped (e.g., since the contact was placed in the queue). In one example, the value of the “skipped” parameter may be a binary value where the value of 0 may indicate that the corresponding contact had not been skipped since the contact was placed in the queue while the value of 1 may indicate that the corresponding contact was skipped at least once. In another example, the value of the “skipped” parameter may be a continuous value where the value of 0 may indicate that the corresponding contact had not been skipped since the contact was placed in the queue while the value of 1 may indicate that the corresponding contact was skipped once, the value of 2 may indicate that the corresponding contact was skipped twice, the value of 3 may indicate that the corresponding contact was skipped thrice, etc. If a contact has a “skipped” parameter value that indicates that the corresponding contact has been skipped at least once, that corresponding contact is not eligible for selection as the TB contact.

The value of the “counter” parameter for a corresponding contact may indicate a number of contacts of a set of contacts in the queue that are (1) between a head of the queue and a paired contact after the corresponding contact was skipped for pairing, and (2) configured to be paired with a different PS than a PS associated with the corresponding contact (e.g., as identified based on the “benchmark” parameter value for the paired contact and the corresponding contact). For example, the “counter” parameter will not have a value for the corresponding contact if the corresponding contact has not been skipped for pairing. In some examples, the corresponding contact may inherit a value for the “counter” parameter, if the corresponding contact was the TB contact, and a paired contact is sequentially before the corresponding contact in a queue of contacts, and the paired contact was associated with the same PS as a PS associated with the corresponding contact (e.g., as identified based on the “benchmark” parameter value for the paired contact and the corresponding contact).

The value of the “skip batch time” parameter may be based on a time when a corresponding contact (that is, a first contact) was skipped for pairing (e.g., a second contact which was sequentially later in the queue than the first contact was paired by the PS associated with the “benchmark” parameter in an out-of-sequence fashion). For example, the “skip batch time” parameter value may be or may be based on a time stamp of when the contact (e.g., the TB contact) was skipped, a length of time since the contact was skipped, etc.

In this disclosure, the “skipped” parameter, the “counter” parameter, and the “skip batch time” parameter are also called “skipper attributes.”

The value of the “TB” parameter may indicate whether a corresponding contact is a TB contact or not. Various methods of determining a value for the “TB” parameter are discussed herein. As mentioned above, a TB contact can be used for determining which PS to benchmark and/or use to select a contact-agent pairing at the next opportunity to select a contact-agent pairing. More specifically, in some embodiments, the PS that is configured to be used for pairing the TB contact with an agent may correspond to the PS that is to be benchmarked. For example, the value of the TB parameter may be a binary value, e.g., “TRUE” or “FALSE”, or “0” or “1”.

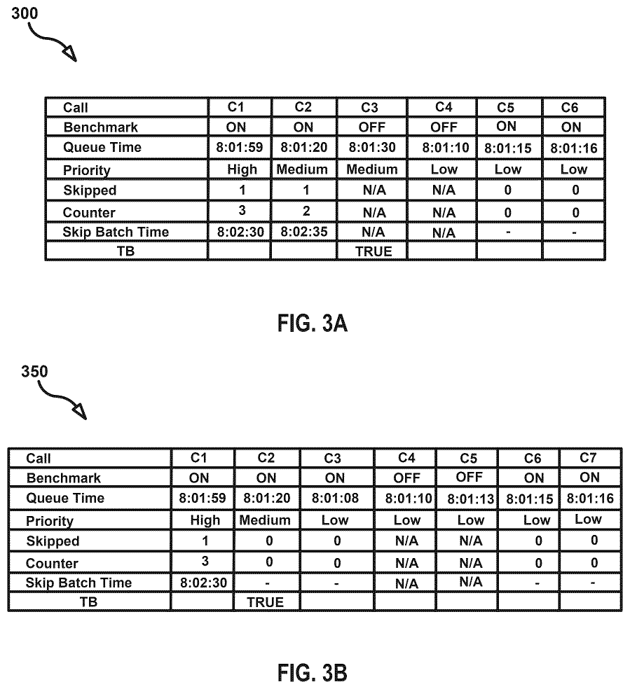

In one example of selecting a TB contact according to the embodiments of there present disclosure, in an exemplary queue attribute table 300 as shown in FIG. 3A, there may be six contacts in a queue, and the six contacts may be C1, C2, C3, C4, C5, and C6. In table 300, C1, C2, C5, and C6 may be associated with a benchmark value of “ON”, indicating a first PS of a set of PSs, wherein the set of PSs comprises a first PS (e.g., indicated by “ON”) and a second PS (e.g., indicated by “OFF”). C3 and C4 may be associated with a benchmark value of “OFF”. In this example, C1 and C2 may be associated with a skipped value of 1, indicating that both contacts have been skipped for pairing by the first PS—that is, the first PS in this example must therefore be an out-of-sequence PS.

C1 and C2 have a “skipped” parameter value of “1”, and, therefore, the methods and techniques of the present disclosure provide that contacts C1 and C2 are not eligible for selection as the TB contact. Therefore, the methods and techniques of the present disclosure provide that the next contact in the queue after the skipped contacts C1 and C2, that is, C3, is selected as a TB contact, as shown by a value of the TB parameter as “TRUE”. Because C3 is the TB contact, the value of the “benchmark” parameter associated with C3 determines which PS should be used to determine the next contact-agent pairing. Because the value of the “benchmark” parameter associated with C3 is “OFF”, indicating that the second PS should be used, the second PS will be used by the contact center system to determine the next contact-agent pairing.

In another example, in an exemplary queue attribute table 350 as shown in FIG. 3B, C1 has a “skipped” parameter value of “1”, and, therefore, the methods and techniques of the present disclosure provides that C1 is not eligible for selection as the TB contact. Therefore, the methods and techniques of the present disclosure provide that the next contact in the queue after the skipped contact C1, that is, C2, is selected as a TB contact, as shown by a value of the TB parameter as “TRUE”. Because C2 is the TB contact, the value of the “benchmark” parameter associated with C2 determines which PS should be used to determine the next contact-agent pairing. Because the value of the “benchmark” parameter associated with C2 is “ON”, indicating that the first PS should be used, the first PS will be used by the contact center system to determine the next contact-agent pairing.

A TB contact may be identified from among a plurality of contacts in a queue based on whether a contact had ever been skipped (e.g., since the contact was placed in the queue). More specifically, in some embodiments, the first contact in the queue, which has the “skipped” parameter of value 0 or of an unknown value (i.e., which does not have the “skipped” parameter of value 1) may be selected as a TB contact. For example, in the queue 300 shown in FIG. 3A, the first contact that does not have the “skipped” parameter of value 1 is C3. Thus, in the queue 300, C3 may be selected as a TB contact. On the other hand, in the queue 350 shown in FIG. 3B, the first contact that does not have the “skipped” parameter of value 1 is C2. Thus, in the queue 350, C2 may be selected as a TB contact.

Even when a contact is selected as a TB contact in a queue of a plurality of contacts, there may be a scenario where a first contact in the queue that is paired with an agent is not the TB contact (the head of the queue).

For example, let's assume that, in the queue attribute table 350 shown in FIG. 3B, C2 is a TB contact, and the second PS is a BP strategy (meaning that when the value of the “benchmark” parameter is ON, indicating the second PS, then the second PS, which is a BP strategy, is applied). In this example, the BP strategy may be applied to C1, C2, C3, C6, and C7 for pairing one of them before the second PS is applied to C4 and C5 (the contacts having the “benchmark” parameter of value OFF) for pairing one of C4 and C5. But since the BP strategy is an out-of-sequence pairing technique, a contact other than C2 may be selected and paired with an agent before C2 is paired with an agent; that is, the BP strategy may select for pairing any contact of the set of contacts comprising C1, C2, C3, C6, and C7. In other words, there may be a scenario where C2 may be skipped from pairing. In such scenario, there may be a need to update one or more of the parameters (e.g., the “skipped” parameter, the “counter” parameter, etc.) associated with the skipped contact (C2) such that C2 may not be selected again as the TB contact.

Accordingly, in some embodiments, the value of the “skipped” parameter and/or the value of the “counter” parameter of a contact may be updated once the contact is skipped. More specifically, in some embodiments, the value of the “skipped” parameter and/or the value of the “counter” parameter of a skipped contact may be updated differently based on information about the skipped contact, the information about the paired contact, and/or information about the contacts between the skipped contact and the paired contact in the queue.

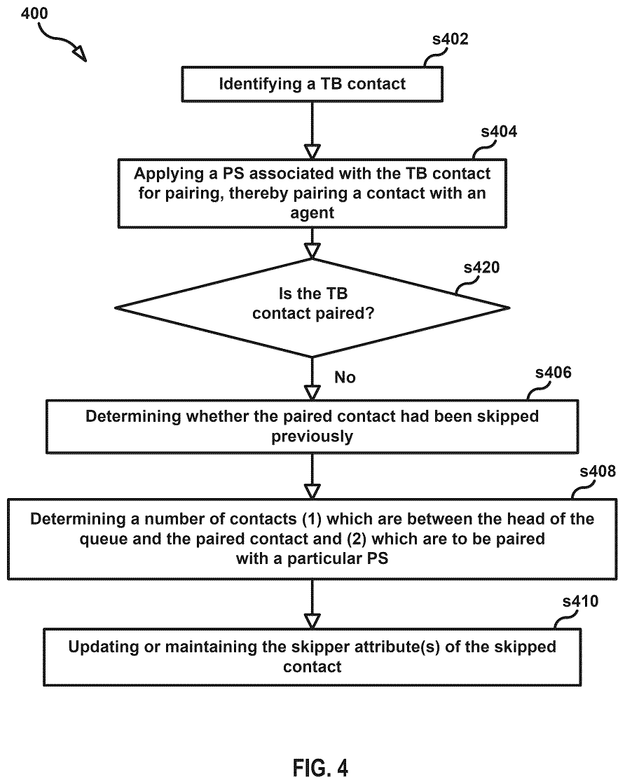

FIG. 4 shows a process 400 of performing a TB according to some embodiments. In this disclosure, the TB performed based on the process 400 may be referred as a “skipper TB”. The process 400 is for updating the value of the “skipped” parameter, updating the value of the “counter” parameter, and/or determining the value of a “TB” parameter of a skipped contact according to some embodiments.

The process 400 may begin with step s402. The step s402 comprises identifying a TB contact from among a plurality of contacts in a queue. As explained above, one way of identifying a TB contact from among a plurality of contacts is by finding the first contact in the queue, which does not have the “skipped” parameter of value 1 (i.e., which has not been skipped). For example, in the queue 350 shown in FIG. 3B, C2 is the first contact in the queue, which does not have the “skipped” parameter of value 0 (note that C1 has the “skipped” parameter of value 1). Thus, in the queue 350, C2 may be selected as a TB contact, and/or a value of the “TB” parameter for C2 may be updated to reflect that C2 is the TB contact (e.g., before this determination, the value of the “TB” parameter for C2 may be null, unavailable, or a value reflecting that C2 is not the TB contact, and after this determination, the value of the “TB” parameter for C2 may reflect that C2 is the TB contact). After performing the step s402, the process 400 may proceed to step s404.

In the step s404, a PS associated with the TB contact is applied for pairing a contact with an agent. For example, in FIG. 3B, let's assume that a first PS is to be applied for pairing when the value of the “benchmark” parameter is ON while a second PS is to be applied for pairing when the value of the “benchmark” parameter is OFF. In this example, since C2 is selected as a TB contact and the PS associated with C2 is the first PS, in the step s404, the first PS is applied for pairing a contact with an agent. In an example where the first PS is an out-of-sequence PS (e.g., such as BP strategy), the first PS may select for pairing any of the contacts in the queue that have a value of the “benchmark” parameter matching the value of the “benchmark” parameter for C2; that is, in this example, the first PS may select for pairings any contact of a set of contacts comprising C1, C2, C3, C6, and C7 because each contact in that set of contacts is associated with the first PS (meaning that only C1, C2, C3, C6, and C7 are candidates for pairing because the remaining contacts in the queue of contacts shown in table 350 have a value of the “benchmark” parameter that does not match C2). That is, the first PS will not be applied to C4 and C5 because they are associated with the second PS. The contact who is paired in step s404 may be removed from the queue of contacts.

After performing the step s404, the process may proceed to step s420 which comprises determining whether the TB contact is paired or not. If the TB contact is paired, the process 400 may end. Otherwise, the process 400 may proceed to steps s406 and s408 (i.e., if the TB contact was not paired during step s404). The steps s406 and s408 may be performed in any sequence or may be performed simultaneously.

The step s406 comprises determining whether the contact paired in the step s404 had been skipped or not. One way to determine whether a contact had been skipped is by checking the value of the “skipped” parameter value. As discussed above, in some embodiments, the value of the “skipped” parameter is a binary value where 0 indicates that a corresponding contact had not been skipped while 1 indicates that the corresponding contact has been skipped.

The step s408 comprises determining a number of contacts (1) which are between the head contact of the queue (e.g., the TB contact) and the contact that was paired in step s404, and (2) which are also configured to be paired with a a different PS than the PS associated with the TB contact (e.g., determined by the “benchmark” parameter value of the TB contact). For example, in the queue 350 shown in FIG. 3B, if contact C7 were the paired contact and contact C2 were the TB contact, then the number of contacts would be 2 because there are two contacts (C4 and C5) that were in the queue between contact C7 and contact C2 (which is both the TB contact and the head of the queue for pairing purposes) and that have a different “benchmark” parameter values than the “benchmark” parameter value of contact C2. After performing the step s408, the process 300 may proceed to step s410.

The step s410 comprises updating or maintaining the value(s) of the parameter(s) of the TB contact based on the results of the steps s406 and s408. For example, the “skipped” parameter value of the TB contact, the “counter” parameter value of the TB contact, and the “skip batch time” parameter value may be updated as discussed further herein. Lastly, the “TB” value may be removed or changed, and a new, subsequent TB contact may be determined. In some examples, as discussed herein, the new, subsequent TB contact is different than the TB contact identified by step s402. In other examples, as discussed herein, the new, subsequent TB contact may be the same TB contact as identified by step s402.

The following three scenarios further explain how the value(s) of the parameter(s) of the TB contact may be updated based on the results of the steps s406 and s408.
Scenario 1) There is at least one contact associated with a second PS between the head of a queue of contacts and a paired contact, when the paired contact is associated with a first PS.

In the queue 350 shown in FIG. 3B, C2 is the head of the queue, C2 is the TB contact, and C7 is a paired contact. In this scenario, the number of contacts (1) which are between C1 and C7 and (2) which are configured to be paired using a particular PS (e.g., second PS, as discussed herein) is two—C4 and C5. Thus, in one example, the value of the “counter” parameter of the skipped call may be updated to be same as the number of contacts determined in the step s408 (e.g., 2). Because contact C2 was skipped in this scenario, for example, the value of the “skipped” parameter of C2 may be updated to 1, and the value of the “skip batch time” parameter may be updated to indicate the time when C2 was skipped.

Here, because C7 was paired before C2 even though C2 is the TB contact, C2 may correspond to a skipped call. Thus, the values of the “skipped” parameter, “counter” parameter, and “skip batch time” parameter of C2 may be updated as explained above.

In a summary the values of the parameters of the TB contact in scenario 1 may be updated as follows:

Skipped = 1,
Counter = the number of OFF calls between the paired call and the head of the queue, and
Skip Batch Time = batch time.

Scenario 2) There is no contact associated with a different PS than a PS associated with the TB contact between the head of a queue of contacts and a paired contact, the paired TB contact has been skipped previously, and the paired contact is sequentially before the TB contact in the queue of contacts.

In the queue 350 shown in FIG. 3B, C2 is the head of the queue, C2 is the TB contact, and C1 is a paired contact. In this scenario, the number of contacts (1) which are between the paired contact (C1) and the head of queue (C2) and (2) which are configured to be paired using a different PS than a PS associated with the TB contact is zero. Thus, there is no contact associated with the second PS (i.e., the contact that is to be paired according to a “benchmark” value of OFF) between the paired contact (C1) and the head of the queue (wC2). Also, as shown in FIG. 3B, the value of the “skipped” parameter of C1 indicates that C1 had been skipped previously.

In this scenario, none of the contacts associated with a PS different from the PS associated with the paired contact in the current queue of contacts was affected by the current pairing of C1 because none of the contacts associated with the different PS would have been eligible for pairing even if pairing were performed in a sequential manner. However, the paired contact C1 has a “counter” value because of affected contacts associated with the different PS in previous pairings before the current pairing. Thus, here, the counter of the TB contact, C2, may be inherited from the paired contact, C1. Accordingly, in this scenario, the value of the “skipped” parameter of the TB contact, C2, may be updated to 1 because C2 was not skipped for pairing when it was eligible for pairing, the value of the “counter” parameter of the TB contact may be updated to be same as the value of the “counter” parameter of the paired contact (e.g., a value of “3” according to FIG. 3B), and/or the value of the “skip batch time” parameter may be updated to indicate the time when the TB contact was skipped.

Here, because C1 was paired before C2 even though C2 is the TB contact, C2 may correspond to a skipped call. Thus, the values of the “skipped” parameter, “counter” parameter, and “skip batch time” parameter of C2 may be updated as explained above.

In a summary the values of the parameters of the TB contact in scenario 2 may be updated as follows:

Skipped = 1,
Counter = The Counter value of paired call if exist, and
Skip Batch Time = batch time.

Scenario 3) There is no contact associated with a different PS than a PS associated with the TB contact between the head of a queue of contacts and a paired contact, and the paired contact had not been skipped. For example, the paired contact is sequentially after the TB contact in the queue of contacts.

In the queue 350 shown in FIG. 3B, C2 is the head of the queue, C2 is the TB contact, and C3 is a paired contact. In this scenario, the number of contacts (1) which are between the head of the queue (C2) and the paired contact (C3) and (2) which are configured to be paired using a different PS than a PS associated with the TB contact is zero. Thus, there is no contact associated with the second PS (i.e., the contact that is to be paired according to a “benchmark” value of OFF) between the paired contact (C3) and the head of the queue (C2). Also, as shown in FIG. 3B, the value of the “skipped” parameter of C3 indicates that C3 had not been skipped previously. In this scenario, the values of the “skipped” parameter, “counter” parameter, and “skip batch time” parameter of a skipped contact may be maintained (i.e., stay unchanged). In a sense in such a scenario, the TB contact inherits the attributes of the paired contact, and the TB contact may be used again as a TB contact (e.g., because C3 would have been the next TB contact if C2 had been the paired contact instead of C3 being the paired contact).

Here, because the paired contact C3 is sequentially after the TB contact C2 in the queue of contacts even though C2 is the TB contact, C2 will not correspond to a skipped contact (e.g., the “skipped” parameter value may indicate that C2 was not skipped or may be missing/unavailable). Thus, the values of the “skipped” parameter, “counter” parameter, and “skip batch time” parameter of C2 may be updated as explained above.

In a summary the values of the parameters of the TB contact in scenario 3 may be updated as follows:

Skipped = 0,
Counter = 0,
Skip Batch Time = Null

Updating the skipper attributes for a set of contacts associated with a first PS when paired contact is associated with a second PS different than the first PS.

It may be necessary to update the skipper attributes for a set of contacts associated with a first PS when the paired contact is associated with a second PS. For example, if the TB contact becomes a contact associated with a second PS and there is at least one skipped contact associated with a first PS ahead of the TB contact in queue order (e.g., if the contacts in the queue of contacts were sorted by time of entry into the queue of contacts), for all contacts in the queue of contacts associated with the first PS which have the “skipped” parameter of value 1 (i.e., skipped attribute=1) and the value of the “skip batch time” parameter is greater than the value of a “queue time” parameter of the TB contact (i.e., Skip Batch Time is bigger than the queue time of the TB contact), then the value of the “counter” parameter (i.e., the Counter attribute) for each of those contacts may be decremented by 1.

In case the value of the “counter” parameter reaches zero for a contact in the queue of contacts, then the value of the “skipped” parameter (i.e., the Skipped attribute) for said contact may be updated to zero and the value of the “skip batch time” parameter may be set to Null, thereby allowing said contact to play a role in defining the TB criteria for upcoming pairings.

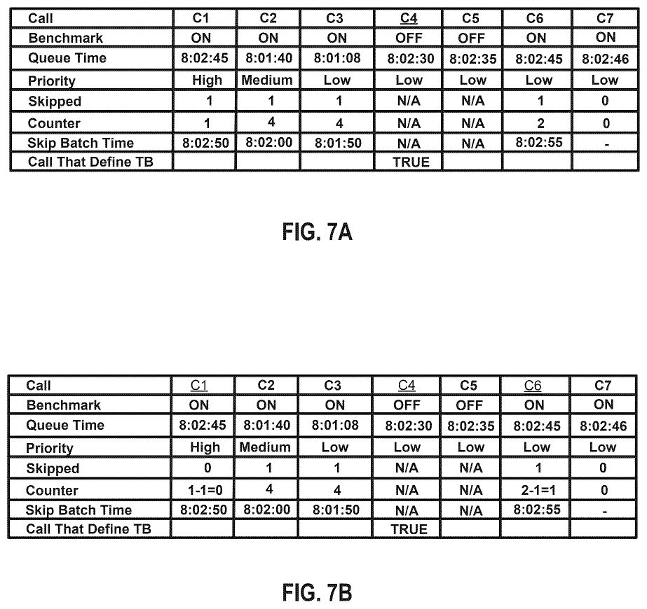

FIGS. 7A and 7B show how the skipper attributes for contacts associated with a first PS may be updated when a contact associated with a second PS is paired (e.g., the paired contact is a contact previously accounted for by the skipper attributes of a set of contacts associated with the first PS). In FIGS. 7A and 7B, C4 (a contact which has a “benchmark” parameter value of “OFF”, indicating the C4 is associated with the second PS) may be paired. Here, there are two contacts associated with the first PS (e.g., having a “benchmark” parameter value of “ON”) that are ahead of the paired contact in the queue, and which also have a “skipped” parameter value indicating that these two contacts had been skipped. Those two contacts are C1 and C6 in this example. C1 and C6 are ahead of C4 because the value of the “queue time” parameter of each of C1 and C6 is greater than the value of the “queue time” parameter of C4 (indicating that C1 and C6 have been waiting longer than C4).

Accordingly, the present disclosure provides for all contacts associated with the first PS, which have the “skipped” parameter of value 1 (i.e., C1, C2, C3, and C6) and which have the “skip batch time” parameter of which the value is greater than the value of the “queue time” parameter of the paired contact to have their “counter” parameter value decremented by 1. Here, the value of the “queue time” parameter of C4 is 8:02:30. Thus among the set of contacts which are associated with the first PS (e.g., the set of contacts in the queue of contacts which have a “benchmark” parameter value of “ON” are C1, C2, C3, and C4), the contacts having the “skip batch time” parameter of which the value is greater than 8:02:30 are C1 and C6. Then the value of the “counter” parameter of each of C1 and C6 may be decremented by 1 as shown in FIG. 7B.

After decrementing the value of the “counter” parameter of each of C1 and C6 by 1, the value of the “counter” parameter of C1 becomes 0. In this case, as explained above, the value of the “skipped” parameter of C1 may be updated to 0 and the value of the “skip batch time” parameter may be set to NULL. Then, C1 may play a role again in defining the TB criteria for upcoming batches.

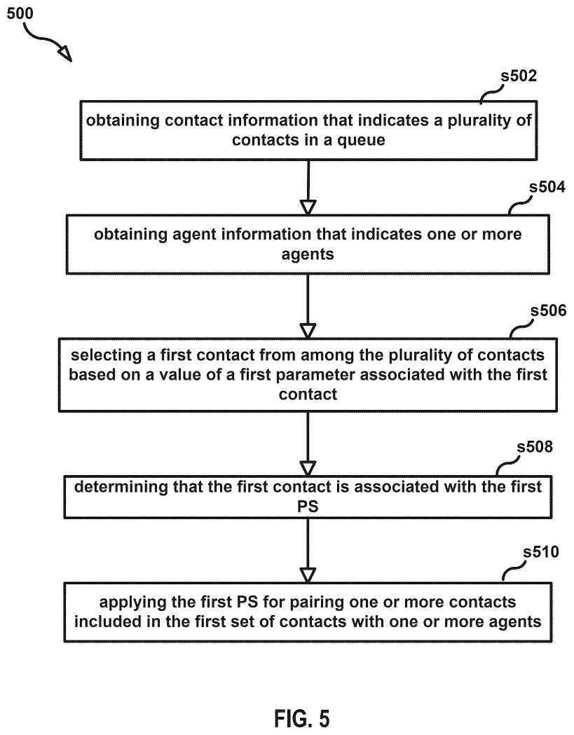

FIG. 5 shows a process 500 according to some embodiments. The process 500 may begin with step s502. The step s502 comprises obtaining contact information that indicates a plurality of contacts in a queue, wherein the plurality of contacts includes a first set of one or more contacts associated with a first pairing strategy (PS) and a second set of one or more contacts associated with a second PS. Step s504 comprises obtaining agent information that indicates one or more agents. Step s506 comprises selecting a first contact from among the plurality of contacts based on a value of a first parameter associated with the first contact, wherein the value of the first parameter indicates whether the first contact was skipped from pairing with an agent since the first contact was placed in the queue. Step s508 comprises determining that the first contact is associated with the first PS. Step s510 comprises applying the first PS for pairing one or more contacts included in the first set of contacts with one or more agents.

In some embodiments, the first set of one or more contacts is configured to be paired with one or more agents using the first PS, and the second set of one or more contacts is configured to be paired with one or more agents using the second PS.

In some embodiments, the first contact is selected based on determining that: the value of the first parameter associated with the first contact indicates that the first contact was not skipped from pairing with an agent since the first contact was placed in the queue, the value of the first parameter is not available, or the value of the first parameter indicates that the first contact is available for selection.

In some embodiments, there is at least one contact before the first contact in the queue, and a value of the first parameter associated with said at least one contact indicates that said at least one contact is skipped from pairing with an agent since said at least one contact was placed in the queue.

In some embodiments, the first set of contacts includes a second contact that is after the first contact in the queue, and applying the first PS for pairing one or more contacts included in the first set of contacts with one or more agents results in pairing the second contact with an agent but failing to pair the first contact with an agent.

In some embodiments, the process 500 comprises determining a number of contacts which are arranged between the first contact and the second contact in the queue and which satisfy a certain criteria.

In some embodiments, the certain criteria indicates that each contact included in the number of contacts is associated with the second PS.

In some embodiments, the process 500 comprises as a result of failing to pair the first contact with an agent, updating the value of the first parameter associated with the first contact.

In some embodiments, the process 500 comprises determining that the number of contacts determined in the above embodiment is not equal to 0; and based at least on determining that the number of contacts determined is not equal to 0, updating a value of a second parameter associated with the first contact to be the determined number of contacts, wherein the value of the second parameter associated with the first contacts indicates a number of contacts which are associated with the second PS (e.g., the number of contacts which are configured to be paired using the second PS).

In some embodiments, the process 500 comprises determining that the number of contacts determined in the above embodiment is equal to 0; and based at least on determining that the number of contacts determined is equal to 0, determining whether to update the value of the first parameter associated with the first contact.

In some embodiments, the process 500 comprises determining that the second contact was not previously skipped from pairing with an agent since the second contact was placed in the queue; and based at least on determining that the second contact was not previously skipped from pairing with an agent since the second contact was placed in the queue, maintaining the value of the first parameter associated with the first contact.

In some embodiments, the process 500 comprises determining that the second contact was previously skipped from pairing with an agent since the second contact was placed in the queue; and based at least on determining that the second contact was previously skipped from pairing with an agent since the second contact was placed in the queue, updating the value of the first parameter associated with the first contact.

In some embodiments, the value of the first parameter associated with the first contact is updated by incrementing the value of the first parameter associated with the first contact by 1.

In some embodiments, the process 500 comprises based at least on determining that the second contact was previously skipped from pairing with an agent since the second contact was placed in the queue, updating a value of a second parameter associated with the first contact to be a value of the second parameter associated with the second contact, wherein the value of the second parameter associated with the second contact indicates a number of contacts which are associated with the second PS and which were skipped from pairing at least until the second contact was paired.

In some embodiments, as a result of applying the first PS, the first contact is paired with an agent, and the process comprises, after determining that the first contact is paired with an agent, identifying, from among the second set of contacts, a first group of one or more contacts (1) which are in the queue longer than the first contact and (2) each of which is associated with a value of the first parameter, indicating that said one or more contacts in the first group were skipped from pairing with an agent.

In some embodiments, the process 500 comprises in response to identifying said one or more contacts in the first group, updating a value of a second parameter associated with a contact included in a second group of one more contacts, wherein the second group of one or more contacts are included in the second set of contacts, and each contact included in the second group is associated with the first parameter having a value indicating that the corresponding contact was skipped from pairing.

In some embodiments, the second group of one or more contacts includes a second contact, as a result of updating the value of the second parameter associated with the contact included in the second group of one more contacts, the value of the second parameter associated with the second contact becomes 0, and the method comprises, as a result of the value of the second parameter associated with the second contact becoming 0, changing a value of the first parameter associated with the second contact to 0.

In some examples, the process 500 and the step s506 further comprises selecting a first contact from among the plurality of contacts based on a value of a first parameter associated with the first contact and based on one or more of: a priority level of the contact, a priority level of another contact in the queue, and/or a priority requirement. In one example, the queue comprises a first set of contacts having a first priority level and a second set of contacts having a second priority level. The second set of contacts is sequentially after the first set of contacts in the queue as the first priority level is higher than the second priority level. In this example, step s506 comprises determining whether there is a priority requirement to pair the first set of contacts before the second set of contacts. If there is a priority requirement, the first contact is selected from the first set of contacts even if all contacts of the first set of contacts are associated with the first parameter having a value indicating that the corresponding contact was skipped from pairing. If there is no priority requirement, the first contact is selected based on determining that: the value of the first parameter associated with the first contact indicates that the first contact was not skipped from pairing with an agent since the first contact was placed in the queue, the value of the first parameter is not available, or the value of the first parameter indicates that the first contact is available for selection.

Therefore, in examples where there is a priority requirement, a pairing strategy associated with contacts in the first set of contacts is prioritized above a pairing strategy associated with contacts in the second set of contacts.

In one example, the first set of contacts includes contacts associated with multiple pairing strategies. When there is a priority requirement and the first set of contacts includes contacts associated with multiple pairing strategies and all contacts in the first set of contacts are associated with the first parameter having a value indicating that the corresponding contact was skipped from pairing, a second contact is selected from the second set of contacts based on determining that: the value of the first parameter associated with the second contact indicates that the second contact was not skipped from pairing with an agent since the second contact was placed in the queue, the value of the first parameter is not available, or the value of the first parameter indicates that the second contact is available for selection. Process 500 then comprises determining a pairing strategy associated with the second contact. Process 500 then comprises selecting the first contact from the first set of contacts based on a pairing strategy associated with the pairing strategy associated with the second contact.

Therefore, in some examples, the queue is:
C1—PS1—High Priority—First Parameter value: Skipped
C2—PS1—High Priority—First Parameter value: Skipped
C3—PS1—High Priority—First Parameter value: Skipped
C4—PS2—Low Priority—First Parameter value: Not Skipped
C5—PS2—Low Priority—First Parameter value: Not Skipped
C6—PS2—Low Priority—First Parameter value: Not Skipped

C1, C2, and C3 comprise the first set of contacts and C4, C5, and C6 comprise the second set of contacts. When there is no priority requirement C4 is selected as the first contact. When there is a priority requirement, any of C1, C2, and C3 are selected as the first contact, and, in some instances, C1 is selected due to its order in the queue.

Therefore, in some examples, the queue is:
C1—PS1—High Priority—First Parameter value: Skipped
C2—PS1—High Priority—First Parameter value: Skipped
C3—PS2—High Priority—First Parameter value: Skipped
C4—PS2—Low Priority—First Parameter value: Not Skipped
C5—PS2—Low Priority—First Parameter value: Not Skipped
C6—PS2—Low Priority—First Parameter value: Not Skipped

C1, C2, and C3 comprise the first set of contacts and C4, C5, and C6 comprise the second set of contacts. When there is no priority requirement C4 is selected as the first contact. When there is a priority requirement, C4 is selected as the second contact, and, C3 is selected as the first contact due to its PS2 matching the PS of the first contact and based on a priority level of C3 (e.g., based on an inclusion of C3 in the first set of contacts.

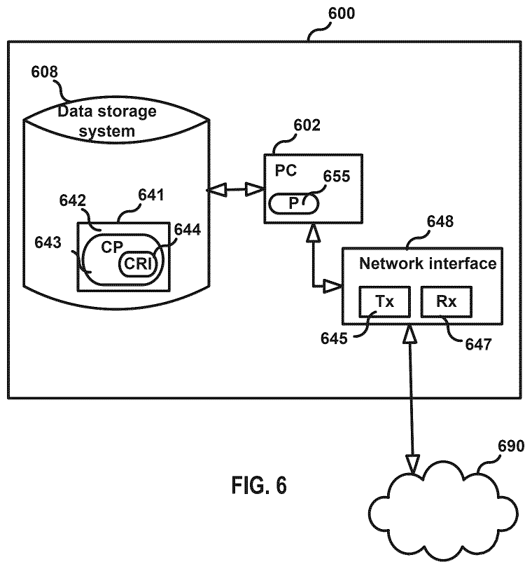

FIG. 6 is a block diagram of an apparatus 600 for performing the process 400 shown in FIG. 4 and/or the process 500, according to some embodiments. As shown in FIG. 6, apparatus 600 may comprise: processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 600 may be a distributed computing apparatus); a network interface 648 comprising a transmitter (Tx) 645 and a receiver (Rx) 647 for enabling apparatus 600 to transmit data to and receive data from other nodes connected to a network 690 (e.g., an Internet Protocol (IP) network) to which network interface 648 is connected (directly or indirectly) (e.g., network interface 648 may be wirelessly connected to the network 690, in which case network interface 648 is connected to an antenna arrangement); and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes apparatus 600 to perform steps described herein (e.g., steps described herein with reference to the flow charts). In other embodiments, apparatus 600 may be configured to perform steps described herein without the need for code. That is, for example, PC 602 may consist merely of one or more ASICs. Hence, the features of the embodiments described herein may be implemented in hardware and/or software.

### SUMMARY OF EMBODIMENTS

A1. A method 500 comprising: obtaining s502 contact information that indicates a plurality of contacts in a queue, wherein the plurality of contacts includes a first set of one or more contacts associated with a first pairing strategy (PS) and a second set of one or more contacts associated with a second PS: obtaining s504 agent information that indicates one or more agents: selecting s506 a first contact from among the plurality of contacts based on a value of a first parameter associated with the first contact, wherein the value of the first parameter indicates whether the first contact was skipped from pairing with an agent since the first contact was placed in the queue: determining s508 that the first contact is associated with the first PS; and applying s510 the first PS for pairing one or more contacts included in the first set of contacts with one or more agents.
A2. The method of embodiment A1, wherein the first set of one or more contacts is configured to be paired with one or more agents using the first PS, and the second set of one or more contacts is configured to be paired with one or more agents using the second PS.
A3. The method of at least one of embodiments A1-A2, wherein the first contact is selected based on determining that: the value of the first parameter associated with the first contact indicates that the first contact was not skipped from pairing with an agent since the first contact was placed in the queue, the value of the first parameter is not available, or the value of the first parameter indicates that the first contact is available for selection.
A4. The method of at least one of embodiments A1-A3, wherein there is at least one contact before the first contact in the queue, and a value of the first parameter associated with said at least one contact indicates that said at least one contact is skipped from pairing with an agent since said at least one contact was placed in the queue.
A5. The method of at least one of embodiments A1-A4, wherein the first set of contacts includes a second contact that is after the first contact in the queue, and applying the first PS for pairing one or more contacts included in the first set of contacts with one or more agents results in pairing the second contact with an agent but failing to pair the first contact with an agent.
A6. The method of embodiment A5, the method comprising: determining a number of contacts which are arranged between the first contact and the second contact in the queue and which satisfy a certain criteria.
A7. The method of embodiment A5, wherein the certain criteria indicates that each contact included in the number of contacts is associated with the second PS.
A8. The method of at least one of embodiments A5-A7, the method comprising: as a result of failing to pair the first contact with an agent, updating the value of the first parameter associated with the first contact.
A9. The method of embodiment A8, the method comprising: determining that the number of contacts determined in embodiment A6 is not equal to 0; and based at least on the determination of embodiment A9, updating a value of a second parameter associated with the first contact to be the determined number of contacts, wherein the value of the second parameter associated with the first contacts indicates a number of contacts which are associated with the second PS (e.g., the number of contacts which are configured to be paired using the second PS).
A10. The method of at least one of embodiments A6-A8, the method comprising: determining that the number of contacts determined in embodiment A6 is equal to 0; and based at least on the determination of embodiment A10, determining whether to update the value of the first parameter associated with the first contact.
A11. The method of embodiment A10, the method comprising: determining that the second contact was not previously skipped from pairing with an agent since the second contact was placed in the queue; and based at least on the determination of embodiment A11, maintaining the value of the first parameter associated with the first contact.
A12. The method of embodiment A10, the method comprising: determining that the second contact was previously skipped from pairing with an agent since the second contact was placed in the queue; and based at least on the determination of embodiment A12, updating the value of the first parameter associated with the first contact.
A13. The method of embodiment A12, wherein the value of the first parameter associated with the first contact is updated by incrementing the value of the first parameter associated with the first contact by 1.
A14. The method of at least one of embodiments A12-A13, the method comprising: based at least on the determination of embodiment A12, updating a value of a second parameter associated with the first contact to be a value of the second parameter associated with the second contact, wherein the value of the second parameter associated with the second contact indicates a number of contacts which are associated with the second PS and which were skipped from pairing at least until the second contact was paired.
A15. The method of embodiment A1, wherein as a result of applying the first PS, the first contact is paired with an agent, and the method comprises, after determining that the first contact is paired with an agent, identifying, from among the second set of contacts, a first group of one or more contacts 1) which are in the queue longer than the first contact and 2) each of which is associated with a value of the first parameter, indicating that said one or more contacts in the first group were skipped from pairing with an agent.
A16. The method of embodiment A15, the method comprising: in response to identifying said one or more contacts in the first group, updating a value of a second parameter associated with a contact included in a second group of one more contacts, wherein the second group of one or more contacts are included in the second set of contacts, and each contact included in the second group is associated with the first parameter having a value indicating that the corresponding contact was skipped from pairing.
A17. The method of embodiment A16, wherein the second group of one or more contacts includes a second contact, as a result of the updating in embodiment A16, the value of the second parameter associated with the second contact becomes 0, and the method comprises, as a result of the value of the second parameter associated with the second contact becoming 0, changing a value of the first parameter associated with the second contact to 0.
B1. A computer program 643 comprising instructions 644 which when executed by processing circuitry 602 cause the processing circuitry to perform the method of at least one of embodiments A1-A17.
B2. A carrier containing the computer program of embodiment B1, wherein the carrier is one of an electronic signal, an optical signal, a radio signal, and a computer readable storage medium.
C1. An apparatus 600 being configured to: obtain s502 contact information that indicates a plurality of contacts in a queue, wherein the plurality of contacts includes a first set of one or more contacts associated with a first pairing strategy (PS) and a second set of one or more contacts associated with a second PS: obtain s504 agent information that indicates one or more agents: select s506 a first contact from among the plurality of contacts based on a value of a first parameter associated with the first contact, wherein the value of the first parameter indicates whether the first contact was skipped from pairing with an agent since the first contact was placed in the queue: determine s508 that the first contact is associated with the first PS; and apply s510 the first PS for pairing one or more contacts included in the first set of contacts with one or more agents.
C2. The apparatus of embodiment C1, wherein the apparatus is further configured to perform the method of at least one of embodiments A2-A17.
D1. An apparatus 600, the apparatus comprising: a memory 642; and processing circuitry 602 coupled to the memory, wherein the apparatus is configured to perform the method of at least one of embodiments A1-A17.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method comprising:
obtaining contact information that indicates a plurality of contacts in a queue, wherein the plurality of contacts includes a first set of one or more contacts associated with a first pairing strategy (PS) and a second set of one or more contacts associated with a second PS;
obtaining agent information that indicates one or more agents;
selecting a first contact from among the plurality of contacts based on a value of a first parameter associated with the first contact, wherein the value of the first parameter indicates whether the first contact was skipped from pairing with an agent since the first contact was placed in the queue;
determining that the first contact is associated with the first PS; and
applying the first PS for pairing one or more contacts included in the first set of contacts with one or more agents.

2. The method of claim 1, wherein
the first set of one or more contacts is configured to be paired with one or more agents using the first PS, and
the second set of one or more contacts is configured to be paired with one or more agents using the second PS.

3. The method of claim 1, wherein
the first contact is selected based on determining that:
the value of the first parameter associated with the first contact indicates that the first contact was not skipped from pairing with an agent since the first contact was placed in the queue,
the value of the first parameter is not available, or
the value of the first parameter indicates that the first contact is available for selection.

4. The method of claim 1, wherein
there is at least one contact before the first contact in the queue, and
a value of the first parameter associated with said at least one contact indicates that said at least one contact is skipped from pairing with an agent since said at least one contact was placed in the queue.

5. The method of claim 1, wherein
the first set of contacts includes a second contact that is after the first contact in the queue, and
applying the first PS for pairing one or more contacts included in the first set of contacts with one or more agents results in pairing the second contact with an agent but failing to pair the first contact with an agent.

6. The method of claim 5, wherein
the method further comprises determining a number of contacts which are arranged between the first contact and the second contact in the queue and which satisfy a certain criteria.

7. The method of claim 5, wherein
the certain criteria indicates that each contact included in the number of contacts is associated with the second PS.

8. The method of claim 5, wherein
the method further comprises, as a result of failing to pair the first contact with an agent, updating the value of the first parameter associated with the first contact.

9. The method of claim 5, wherein
the method further comprises
determining a number of contacts arranged between the first contact and the second contact in the queue and which satisfy a certain criteria;
determining that the determined number of contacts is not equal to 0; and
as a result of determining that the determined number of contacts is not equal to 0, updating a value of a second parameter associated with the first contact to be the determined number of contacts, and
the value of the second parameter associated with the first contacts indicates a number of contacts which are associated with the second PS.

10. The method of claim 5, wherein
the method further comprises:
determining a number of contacts which are arranged between the first contact and the second contact in the queue and which satisfy a certain criteria;
determining that the determined number of contacts is equal to 0; and
as a result of determining that the determined number of contacts is equal to 0, determining whether to update the value of the first parameter associated with the first contact.

11. The method of claim 10, wherein
the method further comprises, as a result of determining that the second contact was not previously skipped from pairing with an agent since the second contact was placed in the queue, maintaining the value of the first parameter associated with the first contact.

12. The method of claim 10, wherein
the method further comprises, as a result of determining that the second contact was previously skipped from pairing with an agent since the second contact was placed in the queue, updating the value of the first parameter associated with the first contact.

13. The method of claim 12, wherein
the value of the first parameter associated with the first contact is updated by incrementing the value of the first parameter associated with the first contact by 1.

14. The method of claim 12, wherein
the method further comprises, as a result of determining that the second contact was previously skipped from pairing with an agent since the second contact was placed in the queue, updating a value of a second parameter associated with the first contact to be a value of the second parameter associated with the second contact, and
the value of the second parameter associated with the second contact indicates a number of contacts which are associated with the second PS and which were skipped from pairing at least until the second contact was paired.

15. The method of claim 1, wherein
as a result of applying the first PS, the first contact is paired with an agent, and
the method further comprises, after determining that the first contact is paired with an agent, identifying, from among the second set of contacts, a first group of one or more contacts (1) which are in the queue longer than the first contact and (2) each of which is associated with a value of the first parameter, indicating that said one or more contacts in the first group were skipped from pairing with an agent.

16. The method of claim 15, wherein
the method further comprises, in response to identifying said one or more contacts in the first group, updating a value of a second parameter associated with a contact included in a second group of one more contacts,
the second group of one or more contacts are included in the second set of contacts, and
each contact included in the second group is associated with the first parameter having a value indicating that the corresponding contact was skipped from pairing.

17. The method of claim 16, wherein
the second group of one or more contacts includes a second contact,
the value of the second parameter associated with the second contact is 0, and
the method further comprises, as a result of the value of the second parameter associated with the second contact being 0, changing a value of the first parameter associated with the second contact to 0.

18. A non-transitory computer readable storage medium storing instructions for configuring an apparatus comprising processing circuitry operable to execute the instructions to perform the method of claim 1.

19. An apparatus, the apparatus comprising:
a memory; and
processing circuitry coupled to the memory, wherein the apparatus is configured to perform a method comprising:
obtaining contact information that indicates a plurality of contacts in a queue, wherein the plurality of contacts includes a first set of one or more contacts associated with a first pairing strategy (PS) and a second set of one or more contacts associated with a second PS;
obtaining agent information that indicates one or more agents;
selecting a first contact from among the plurality of contacts based on a value of a first parameter associated with the first contact, wherein the value of the first parameter indicates whether the first contact was skipped from pairing with an agent since the first contact was placed in the queue;
determining that the first contact is associated with the first PS; and
applying the first PS for pairing one or more contacts included in the first set of contacts with one or more agents.

20. The apparatus of claim 19, wherein
the first set of one or more contacts is configured to be paired with one or more agents using the first PS, and
the second set of one or more contacts is configured to be paired with one or more agents using the second PS.
